(19) United States
(12) Patent Application Publication
(10) Pub. No.: US 2013/0210154 A1
(43) Pub. Date: Aug. 15, 2013

(54) HAND-DEVICE, AND METHODS FOR EXAMINING A CORRODIBLE METAL OBJECT FOR CORROSION

(71) Applicants: Stefan Dieckhoff, Lilienthal (DE); Peter Plagemann, Bremen (DE); Philippe Vulliet, Annecy (FR); Manfred Nachbar-Zielinski, Stade (DE)

(72) Inventors: Stefan Dieckhoff, Lilienthal (DE); Peter Plagemann, Bremen (DE); Philippe Vulliet, Annecy (FR); Manfred Nachbar-Zielinski, Stade (DE)

(73) Assignees: Dow Deutschland Anlagengesellschaft MbH, Stade (DE); Fraunhofer-Gesellschaft Zur Förderung Der Angewandten Forschung E.V., München (DE)

(21) Appl. No.: 13/704,747

(22) PCT Filed: Jun. 1, 2011
(86) PCT No.: PCT/EP2011/059160

§ 371 Date: May 1, 2013

(30) Foreign Application Priority Data
Jun. 15, 2010 (DE) 10 2010 030 131.0

(51) Int. Cl. G01N 17/04

(52) U.S. Cl. CPC G01N 17/04
USPC 436/2; 73/865.8; 422/53

(57) ABSTRACT

A hand-device is described for penetrating a heat-insulating layer of a corrodible metal object and for examining a pipeline for corrosion, preferably for penetrating a heat-insulating layer of a corrodible metal pipeline, with a penetrating body that comprises a pointed section for displacing the insulating layer and a holding section for receiving a driving force, and a detecting device for generating a signal as a response to a stimulus caused by corrosion, wherein the detecting device is arranged proximally to the pointed section of the penetrating body. Corresponding methods as well as uses are also described.

The present invention relates to a hand-device as well as (in general) a method for penetrating a heat-insulating layer of a corrodible metal object and examining the object for corrosion, preferably (specifically) for penetrating a heat-insulating layer of a corrodible metal pipeline and examining the pipeline for corrosion. The present invention also relates to the corresponding use of the hand-device according to the invention.

The use of the hand-device for examining heat-insulated corrodible metallic pipelines (hereinafter also simply termed “pipelines”) is particularly preferred in the context of the present invention; the use of the hand-device according to the invention is however not restricted to the examination of such pipelines.

U.S. Pat. No. 6,054,038A discloses a flexible corrosion sensor as a hand-device, which uses electrochemical impedance spectroscopy in order to detect coating degradation and corrosion of coated and uncoated metals. The hand-operated and flexible corrosion sensor is pressed against the surface of the sample to be inspected. An EIS spectrum can be obtained in this way, by means of which the degree of degradation of the coating or material can be determined.

CA 2 146 744 discloses a floor probe, which enables the floor in external regions, in particular in the vicinity of oil pipelines or natural gas pipelines to be investigated. The probe enables floor properties located in corrosive environments to be monitored. In particular the probe facilitates the measurement of the floor resistivity at different depths.

US 2003/055326 A1 discloses devices and methods for taking samples of a biological fluid and for measuring a specific constituent within the biological fluid. In general these devices contain a sampling means that is designed to penetrate a skin surface, in order to gain access to the biological fluid, as well as concentrically spaced apart operating and reference electrodes that are positioned within the longitudinal sampling means, and which define an electrochemical cell for measuring the concentration of the analyte within the biological fluid.

The occurrence of corrosion on heat-insulated pipelines occurs in refineries, petrochemical plants, nuclear power stations as well as in general facilities of the on-shore and off-shore industry, but also in other technical and industrial facilities. Corrosion is understood in this context to denote the corrosion occurring on the outer surface of a pipe, for example as a result of condensation water penetrating the material of the insulation layer. Affected raw materials are commonly carbon steel, manganese steel, low-alloy as well as austenitic stainless steel. In the case of austenitic steel alloys the corrosion is also manifested as pitting.

Particularly at risk are all flexible tube regions in which, on account of damage to the insulation layer, relatively large amounts of condensation water can collect in the vicinity of the pipe. This affects regions of non-operational pipe ends, pipe hangers, valves, fittings and so on. However, corrosion also occurs in all other regions underneath the insulation layers.

A basic problem in heat-insulated pipelines is that the corrosion often remains undetected on account of the insulation layer covering the corrosion. Consequently in practice the insulation layer surrounding pipelines is removed at specific intervals or on the mere suspicion of corrosion, so as to be able to carry out a corrosion investigation. This is associated with enormous maintenance expenditure and effort.

Other known examination methods for detecting corrosion, such as for example ultrasound or eddy current testing, also require removal of the insulation layer from the pipeline.

Of course, methods exist that do not require the removal of the insulating layer, such as for example thermographic methods. These however can be used only in certain circumstances and furthermore either do not provide reliable information on corrosion damage, or they cannot be used during the operation of a facility.

Radiographic methods are of course able to detect corrosion damage without removing the insulating layer, but for safety reasons cannot be employed during the operation of a plant; they are also extremely costly in terms of equipment and labour.

Against this background the object of the invention was to provide a device and a method that reliably permit the examination for corrosion in heat-insulated corrodible metallic objects in general and pipelines in particular, and that keep the labour expenditure involved in the implementation of the corrosion examination as low as possible.

The invention is discussed hereinafter in particular with reference to the special application (pipelines); the explanations apply as appropriate to the examination of other corrodible metallic objects.

The invention achieves the aforementioned object with a hand-device of the type mentioned in the introduction, wherein the hand-device comprises a penetrating body that has a pointed section for displacing the insulating layer and a holding section for receiving a driving force, and a detecting device for generating a signal in response to a stimulus produced by corrosion, wherein the detecting device is arranged proximally to the pointed section of the penetrating body. The invention utilises the knowledge that an insulating layer, such as is typically used in pipelines for thermal insulation, can be deformed plastically and elastically up to a certain limit. Consequently the material of the insulating layer is able to be displaced as a result of the penetration of a penetrating body, and after removal of the penetrating body returns to its original shape, whereby the volume previously occupied by the penetrating body is—at least for the most part—reoccupied by the material of the insulating layer, so that the insulating layer can continue to perform its insulating action without having to be replaced. The hand-device according to the present invention allows such a minimally invasive intervention, since it comprises a penetrating body that has a pointed section for displacing the insulating layer. The hand-device can be introduced into the heat-insulating layer surrounding the pipeline, by means of a transfer of force from an operator to the holding section, whereby the insulating layer is partially displaced. Owing to the fact that a detecting device is arranged proximally to the pointed section of the penetrating body, it is possible to carry out a detection for corrosion in the immediate vicinity of the pipeline, or in any case in the section in which the detecting device is located after reaching a certain, desired penetration depth. The examination of a pipeline for corrosion is understood in this connection to mean that an examination for corrosion products takes place.

In this connection the invention also makes use of the fact that when corrosion occurs corrosion products are formed, for example iron ions, which are located on or in close proximity to the pipeline. Normally the corrosion products also penetrate into the material of the insulating layer. The hand-device according to the invention is able, by penetrating the insulating layer to a desired depth, to detect the presence of corrosion products and by means of the envisaged detecting device to generate a signal in response to the stimulus produced by the presence of the corrosion products.

In the context of the invention all materials that can be penetrated by means of the hand-device formed according to the invention are suitable as material of the insulating layer. In this connection the heat-insulating layer may preferably consist of a material with a density in the range from 16 to 200 kg/m³. For example, mineral wool with a density in the range from 16 to 50 kg/m³, elastomeric foam with a density in the range from 60 to 80 kg/m³, PU foam with a density in the range from 65 to 75 kg/m³ and foamed glass with a density in the range from 100 to 200 kg/m³ may be mentioned, although the above list is not exhaustive.

The pointed section of a hand-device according to the invention is preferably reversibly and detachably arranged on a base element of the penetrating body. In this way the pointed section can be replaced as desired after an examination has been conducted. Preferably the pointed section has a coupling section, which forms a screw connection, a socket-type connection, a bayonet closure or a clamping connection with a correspondingly shaped section in the base element of the penetrating body. In this way a highly accurately reproducible positioning of the pointed section relative to the base element of the penetrating body, as well as a simple installation and dismantling, are ensured.

In a preferred embodiment of the hand-device according to the invention the penetrating body and/or the pointed section has/have a circular, elliptical or polygonal cross-section. The flexible tube cross-sectional shape of the penetrating body depends essentially on the requirements that are to be placed on the bending strength and torsional strength, which in turn is determined by the density of the material of the insulating layer being penetrated. A circular or elliptical cross-section has a small circumference in relation to its surface area. With regard to the overall penetrating body and/or the pointed section, this means that such a cross-section geometry has a small enveloping surface in relation to its internal volume. This has a positive influence on the penetration resistance of the penetrating body and of the pointed section. If having regard to the penetration resistance it is also possible to choose a polygonal cross-sectional area, then this has the advantage that the bending and torsional strength on account of the polygonal profile are relatively higher, for an identical body volume, than in the case of a circular or elliptical cross-sectional area.

The hand-device according to the invention is advantageously modified in that the penetrating body and/or the pointed section is/are formed straight, curved or spiral-shaped. A shaped penetrating body is advantageous if the material of the heat-insulating layer is to be penetrated by the shortest path in the direction of the internally lying pipe to be examined. By following the shortest possible path within the material of the insulating layer the said material is also subjected to only minimum damage. In certain situations it may however be necessary to avoid certain obstacles, such as for example signal lines or mechanical structural parts, likewise arranged in the interior of the material of the heat-insulating layer, so that these are not damaged by the penetrating body, or conversely the penetrating body and/or the pointed section are not damaged by these obstacles. In such a case it is particularly advantageous if the penetrating body is formed curved. With a constant curvature of the path of the penetrating body and/or of the pointed section, the section of the material of the insulating layer penetrated by the curved penetrating body and/or pointed section also comprises a channel containing displaced material and corresponding in cross-section to the penetrating hand-device. The traversed path within the insulating layer is of course larger compared to the straight configuration of the penetrating body and/or of the pointed section, which however is acceptable in an individual case if this means that certain obstacles can be successfully avoided. Furthermore it may be advantageous to penetrate materials not in a straight or curved path, but in a spiral-shaped forward movement. This is particularly advantageous if the density of the insulating material to be penetrated is so high that a simple impact movement in the penetration direction is not sufficient to displace the material of the insulating layer sufficiently and would involve the threat of damage to the hand-device. When penetrating the material of the heat-insulating layer in a spiral manner, a high torsional force can be exerted similar to the case of a conventional corkscrew, by means of which the penetrating body and/or the pointed section can bore into the insulating layer in the manner of a screw thread.

Preferably the penetrating body and/or the pointed section of the hand-tool according to the invention has/have a maximum cross-sectional diameter in the range from 4 to 20 mm. It is preferred in this connection if the maximum cross-sectional diameter is in the range from 4 to 16 mm. In a particularly preferred embodiment the penetrating body and/or the pointed section have a maximum cross-sectional diameter in the range from 4 to 12 mm.

In a preferred hand-tool the distance between the penetrating end of the pointed section of the penetrating body and the holding section is in the range from 150 to 1000 mm. It is advantageous to configure the penetrating body and the pointed section for specific applications cases, so that through an inclined penetration of the material of the insulating layer of a pipeline, an examination for corrosion can be carried out in a larger area through one and the same entry opening. Also, pipelines that are installed at greater heights can also easily be reached in this way. It is particularly preferred if the distance between the penetrating end of the pointed section of the penetrating body and the holding section is in the range from 150 to 600 mm.

In a further preferred embodiment of the proposed hand-device the holding section has a length in the range from 110 to 220 mm. Depending on whether it is intended in the individual case to guide the hand-device single-handedly or with both hands, a corresponding length of the holding section is preferably flexible tube.

Preferably the pointed section of the hand-device according to the invention is formed at its penetrating end as a unilaterally tapered or multilaterally tapered wedge, or as a wedge-shaped or projectile-shaped tip, or as a wedge-shaped, spherical or projectile-shaped stump.

Preferably the detecting device of a hand-device according to the invention is designed as a replaceable part. This embodiment can also be advantageously modified further in that the detecting device is replaceably arranged in a recess, the recess being formed in the penetrating body, preferably in the pointed section. The arrangement of the detecting device as a replaceable part in the penetrating body enables the pointed section to be replaced after use and/or damage, the detecting device remaining within the recess in the penetrating body. The mechanical structural part of the pointed section can consequently be replaced independently of the detecting device, if the detecting device is arranged not in the pointed section but in the base element of a hand-device according to the invention. This is particularly advantageous if the pointed section itself is worn, damaged or consumed, but the detecting device itself is still capable of further use. In any case, the recess is preferably formed in the pointed section. The detecting device is then arranged in the pointed section, which has the advantage that a detecting device that is intended for example for a single use can after use with the pointed section be replaced quickly and with minimal manipulation.

According to a further preferred implementation of the present invention the detecting device comprises for generating a signal a plurality of electrodes and/or one or more light guides and/or an indicator responding to the stimulus to be identified.

Preferably the hand-device according to the invention comprises means for transporting and/or separating and/or removing one or more detection means. The detection means is for example an indicator fluid or an indicator rod subdivided into expected fracture sections, which in the pointed section extends outwardly into the medium surrounding the pointed section and is separated after use. The already used section is preferably separated at the site of the investigation and remains there, or is separated after removing the hand-device from the heat-insulated pipeline. The means for tracking the detection agent is advantageously formed as a flexible tube, for example for transporting indicator fluid, or for example is also preferably coupled to a feed device for the use of an indicator rod subdivided into expected fracture sections as an arrangement of guide rails.

Electrodes provided in the detecting device can preferably be used to detect water or moisture. This can take place for example if the conductivity of the ambient medium between two or more electrodes is measured. Starting from a previously performed calibration performed, a representative voltage signal indicating the presence of water in the surroundings of the detecting device can then be generated corresponding to the altered conductivity. Light guides provided in the detecting device, preferably as elements of a fibre-optic detection system, record a change in light wavelength and/or emit light in the surroundings of the detecting device. The emitted light is reflected by the surroundings of the pointed section. The reflected light is received by a light guide and transmitted as a generated response signal. An indicator that indicates the presence of corrosion products, for example iron ions, is preferably additionally used in a fibre-optic examination method. The display indicating the presence of corrosion products is preferably a colour change. On account of the colour change preferably light with an altered wavelength is detected by the light guide of the detecting device, and the response signal thereby generated is altered due to the colour change. The colour change that is detected in this way by the detecting device is evaluated preferably colorimetrically or spectroscopically. By matching it with calibration data the presence or absence of corrosion products can thus be reliably confirmed.

According to a further advantageous embodiment of the hand-device according to the invention, the penetrating body is formed as a hollow body, wherein signal lines for transmitting the signals representative of the stimulus to be identified and/or power supply means are arranged in the interior of the hollow body. The signal lines and/or power supply means are preferably connected to the detecting device.

The aforementioned means for transporting and/or separating or removing one or more detection means may also be arranged in the interior of the hollow body.

The hand-device according to the invention preferably has a holding section, which comprises power supply means and/or means for transmitting signals from the detecting device to a device for processing the signals. This embodiment is especially advantageous if the hand-device itself has no active power supply, or does not contain its own device for processing signals. Such a hand-device is characterised in particular by an extremely compact configuration. The signals generated by the detecting device are preferably transmitted in a wireless manner or by cable connection to an external data processing system.

In a further preferred modification of the hand-device it is envisaged that the hand-device comprises a device for processing the signals and optionally a device for displaying the results of the signal processing, wherein the device for processing the signals and optionally the device for displaying the results of the signal processing is preferably arranged within the holder section and/or within the penetrating body. Particularly for intended uses in which an additional arrangement of an external data processing unit with a device for processing the detected signals is not possible or practicable, a configuration of the hand-device according to the invention that comprises a device for processing signals as well as a device for displaying the results of the signal processing is advantageous. With such a hand-device it is possible to display the result immediately after carrying out the examination for the presence of corrosion products. In this connection it is in many cases sufficient to define and display a “corrosion present” and a state “corrosion not present” state, which enables the user to make technically meaningful statements regarding the examination. The calibration in such a case is preferably carried out so that although false positive notifications are possible, no false negative notifications are possible however. In fact, in practice it is of course possible in individual cases to free a pipeline from its insulating layer so as to establish that (contrary to the false positive notification of the hand-device according to the invention) there is in fact no corrosion. On the other hand it is not possible to find that a pipeline is corrosion-free if this is not in fact the case (false negative notification). The time interval till the next maintenance date may then already be too long, and pipe failure can occur. This must of course be avoided at all costs.

Preferably the hand-device according to the invention also comprises power supply means, which are preferably in the form of a battery and/or a connection to an external electrical power supply.

A preferred hand-device according to the invention furthermore contains a guide device for the guided penetration of the insulating layer, with a recess through which the pointed section and the penetrating body pass (preferably free of play), wherein the guide device preferably comprises a handle. Such a hand-device according to the invention is particularly preferred if the distance between the penetrating end of the pointed section of the penetrating body and the holding section is greater than 500 mm. The guide device can for example be a sleeve provided with a handle, wherein the sleeve receives the penetrating body and/or its pointed section free from play. A user can therefore also guide a particularly elongated variant of the hand-device with two hands and position it accurately at an examination site and carry out the penetration of the material of the insulating layer. The guide device preparably has an inlet section, shaped in the manner of a funnel, so as to facilitate the introduction of the pointed section into the recess. Preferably means are provided in order to fix the guide device in situ in the region of an examination to be conducted on the pipeline or an insulating layer or the like, so that the guide device itself no longer has to be held directly by the operator, who can concentrate on introducing the guide device into the recess.

The hand-device according to the invention is preferably modified in such a way that the holding section is ergonomically contoured so it can be gripped with one or both hands, and/or an extension element is arranged on the holding section. The extension element is preferably designed so as to increase the range for a user of the hand-device, so that the user can carry out a corrosion examination on difficultly accessible pipelines or relatively elevated pipelines. The ergonomic contour of the holding section for one or both hands means that it is less tiring for a user and improves the transfer of force from the user to the hand-device.

The present invention also relates to a method for examining a corrodible metal object provided with a heat-insulating layer for corrosion, preferably a pipeline surrounded by a heat-insulating layer, comprising the following steps:
penetration of the heat-insulating layer by means of a hand-device according to the invention, preferably a hand-device according to a modification identified hereinbefore as preferred, so that the pointed section comes to abut against the object, or is spaced from the object at a distance of less than 50 mm, and
examining the object for corrosion by means of the detecting device.

Preferred is a method according to the invention for examining a pipeline surrounded by a heat-insulating layer for corrosion that comprises the following steps:

Penetration of the heat-insulating layer surrounding the pipeline by means of a hand-device according to the invention, preferably a hand-device according to a modification identified hereinbefore as preferred, so that the pointed section abuts against the pipeline or is at a distance from the pipeline of less than 50 mm, and examining the pipeline for corrosion by means of the detecting device.

The preferred method according to the invention preferably comprises one or more of the following steps: forming an opening in the insulating cover layer of a heat-insulated pipeline; penetrating a spacer layer that surrounds the heat-insulating layer; transferring the collected measurement values to a signal processing device. These steps are respectively mutually independent alternatives for the modification of the method according to the invention, though in many cases it is advantageous or necessary to combine two or more of the steps.

The invention also relates to the use (preferred in the context of the present invention) of a hand-device according to the invention, preferably a hand-device according to a modification identified hereinbefore as preferred, for examining a pipeline for corrosion, preferably in addition for detecting moisture.

The invention also relates to a pipeline system with a device for detecting corrosion products, comprising a pipeline, a heat-insulating layer surrounding the pipeline, and a hand-device according to the invention for penetrating the material of the heat-insulating layer, preferably a hand-device according to a modification identified hereinbefore as preferred.

The pipeline system according to the invention comprises in preferred modifications a spacer layer of a contoured material, which is arranged between the heat-insulating layer and an insulating cover layer, wherein the hand-device penetrates the spacer layer.

The invention is described in more detail hereinafter with the aid of preferred embodiments and with reference to the accompanying figures, in which:

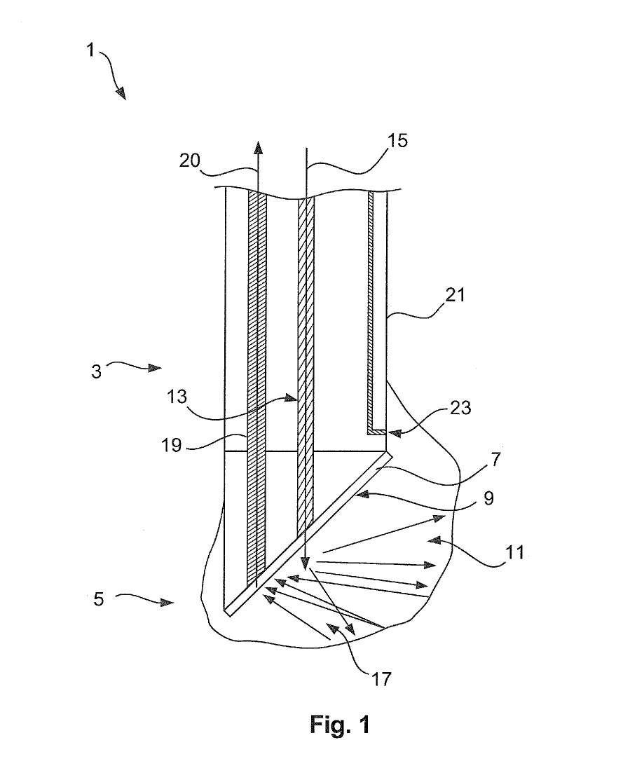

FIG. 1 is a schematic sectional view of part of a hand-device according to the invention according to a preferred embodiment;

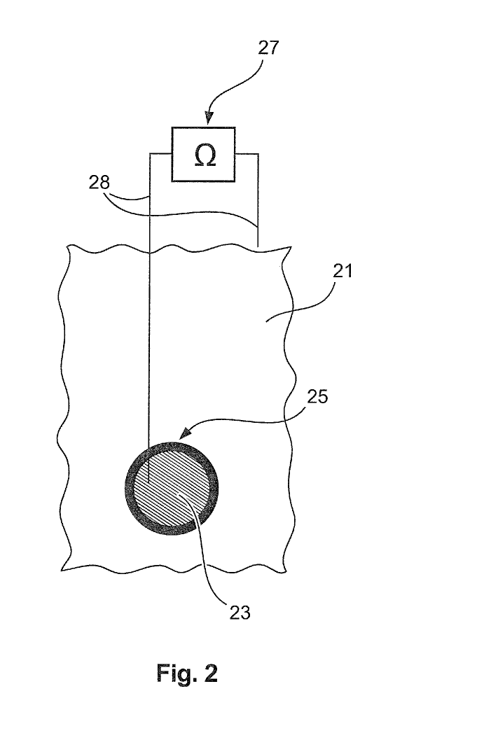

FIG. 2 is a schematic representation of a surface section of a hand-device of FIG. 1 according to a preferred embodiment;

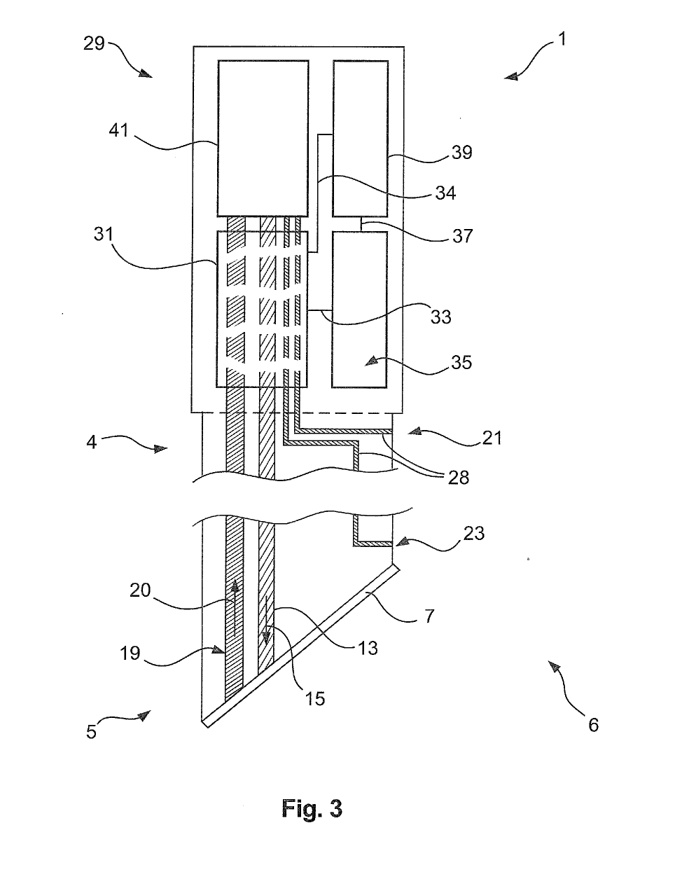

FIG. 3 is a schematic sectional view of a preferred embodiment of the hand device in accordance with the invention, according to a preferred embodiment;

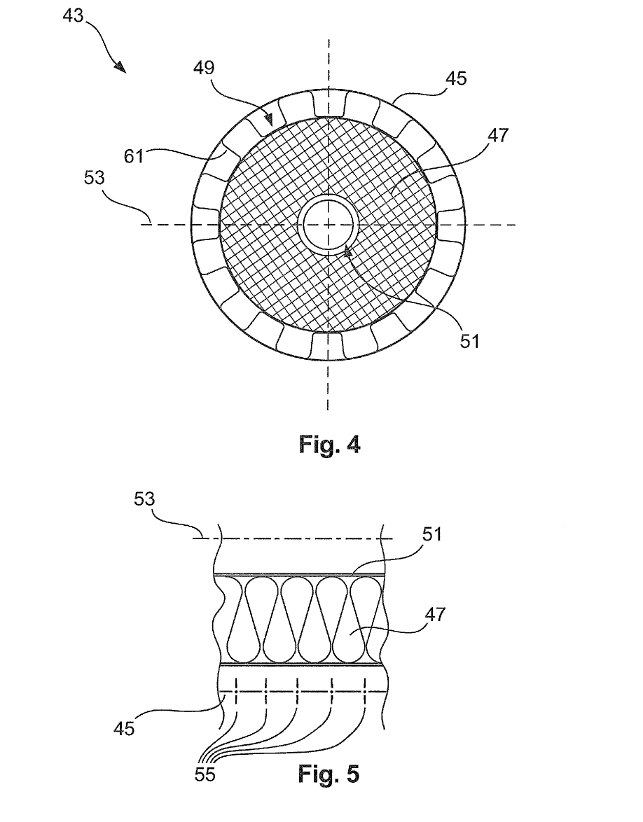

FIG. 4 is a schematic cross-sectional view of a pipeline;

FIG. 5 is a section-wise schematic cross-sectional representation of a pipeline;

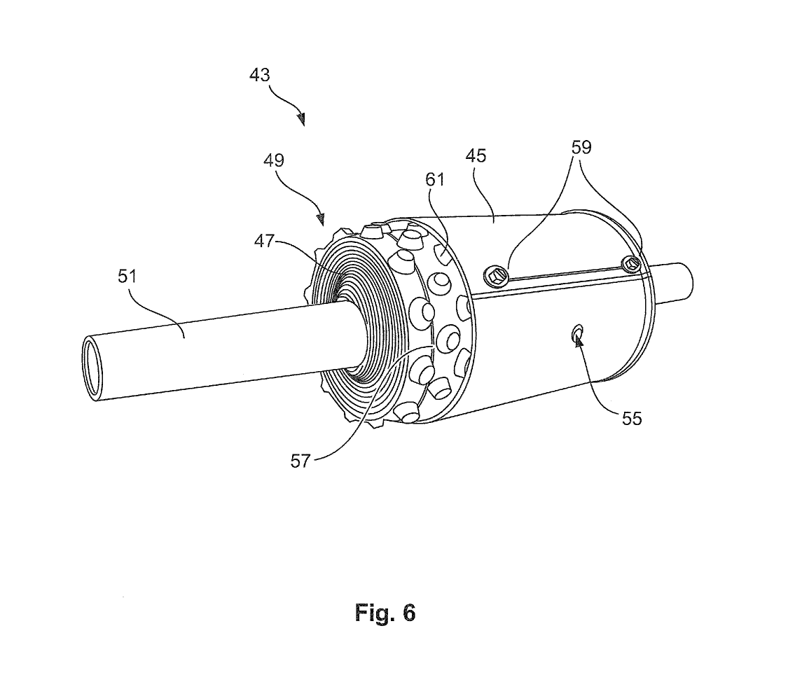

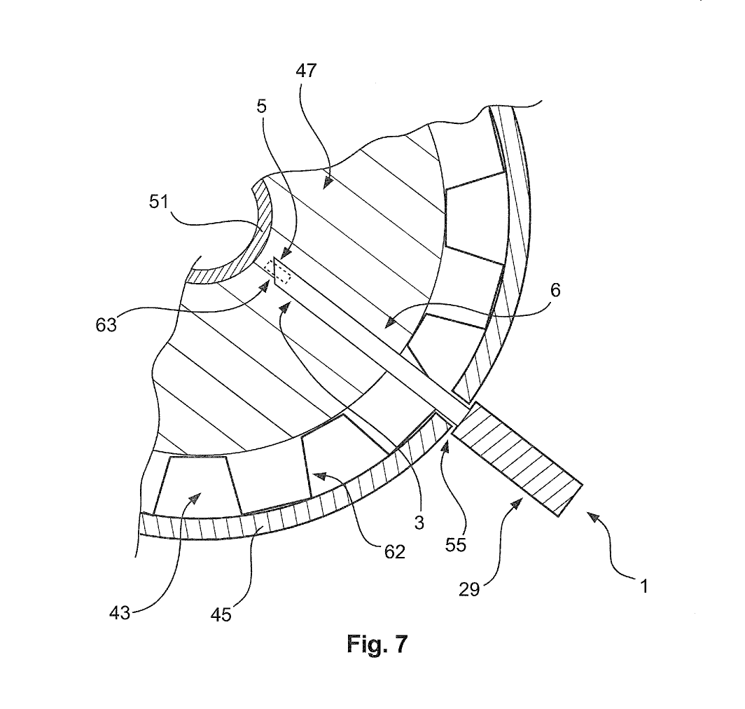

FIG. 6 is a schematic, spatial representation of a heat-insulated pipeline; and

FIG. 7 is a schematic detailed view of a cross-section of a pipeline system according to the present invention.

### 1. DESCRIPTION OF THE SUBJECT MATTER

The hand-device 1 according to the invention illustrated in FIG. 1 comprises a pointed section 3, on whose lower end in the figure there is provided a penetrating end 5. The penetrating end 5 is formed as a unilaterally tapered wedge. A plate 7 is arranged on the tapered surface of the penetrating end 5. The plate 7 is designed to be transparent to the passage of light. The plate 7 is also designed so as to receive an indicator 9 on its surface, which indicator is formed (in a manner not shown) as a film.

FIG. 1 furthermore shows schematically that the pointed section 3 and in particular the penetrating end 5 are surrounded by material of a heat-insulating layer 11. The heat-insulating layer 11 reflects light, which is guided by means of a light guide 13 in the emission direction 15 to the penetrating end 5 of the hand-device 1 and leaves the hand-device 1 through the plate 7. The light reflected in the heat-insulating layer 11 passes again—indicated by the reference numeral 17—through the plate and is further guided by means of a light guide 19 in the immission direction 20 within the hand-device, for example to a photometer (not shown). The photometer (not shown) is designed so as to measure the wavelength of the immited light and to compare it with the known wavelength of the emitted light. A change of the indicator film 9 as a result of the presence of corrosion products produces a change in wavelength, which can be detected in this way. For further details reference should be made to the exemplary embodiment described hereinafter.

The embodiment of a hand-device 1 illustrated in FIG. 1 furthermore comprises an electrode 21, which in the present case is formed by the outer wall of the pointed section 3.

A second electrode 23 is formed partly on the surface of the pointed section 3, and is designed to conduct current also in the interior of the pointed section 3 of the hand-device 1. An example of the arrangement of the electrodes 21, 23 is illustrated in FIG. 2.

The surface of the pointed section 3 illustrated in FIG. 2, which is formed as the electrode 21, is separated by means of an insulation 25 from the second electrode 23. The second electrode 23 is designed in the form of a button on the surface and also extends within the pointed section 3 (see FIG. 1). The electrodes 21, 23 are furthermore also designed to communicate by means of conducting paths 28 with a device 27 for measuring resistance. The device 27 for measuring resistance may exist as an independent unit or may be integrated into the hand-device as part of a device for processing signals 31 (see FIG. 3).

FIG. 3 shows a schematic construction of a preferred embodiment of the hand-device 1 according FIG. 1. The illustrated hand-device 1 comprises a pointed section 3 (see FIG. 1) with a penetrating end 5, which is connected (in a manner not shown) with a base element 4 to a penetrating body 6. Light guides 13, 19 are passed from the penetrating end 5 of the pointed section of the penetrating body 6 through the base element 4 and are connected in a signal-conducting manner to a device 31 for the signal processing, which is arranged in the interior of a holding section 29 formed as a handle. The light guides 13, 19 serve in this connection respectively for the emission in the direction of the arrow 15 or for the immission in the direction of the arrow 20. The immission as well as the emission take place by passage through the plate 7. Furthermore conducting paths 28 are provided, which extend between the electrodes 21, 23 and the device 31 for the signal processing. Signals processed by the signal processing device 31 are transmitted by means of a signal line 34 as a result signal, preferably as an electrical signal, to a device 39 for displaying the results of the signal processing. A device 35 for supplying power is furthermore provided in the interior of the holding section 29. The device 35 for supplying power is connected by means of conducting paths 33 to the device 31 for the signal processing and by a conducting path 37 to the device 39 for displaying the results of the signal processing, so as to ensure the function of the devices 31, 39.

The device 31 for the signal processing is furthermore designed to pass the signals fed into it, by means of the signal lines 28, 13, 19 to a device 41 for transmitting signals. The device 41 for transmitting signals can be a wireless transmission device or a cable-connected transmission device. The signals can be transmitted in their original signal form, or transmitted after conversion into analogue or digital representative signals by the device 41, to an external device for the data processing.

FIGS. 4 to 6 show exemplary implementations of heat-insulated pipelines, for the examination of which the hand-device 1 according to the invention is adapted. Thus, FIG. 4 shows a schematic cross-sectional view through a heat-insulated pipeline 43. The heat-insulated pipeline 43 comprises an insulating cover layer 45, which may consist of aluminium, steel or plastics. A heat-insulating layer 47 is provided within the heat-insulated pipeline 43. The heat-insulating layer 47 and the insulation cover layer 45 are separated from one another by means of a contoured spacer layer 49. The spacer layer 49 comprises a plurality of contour elements 61, which extend between the heat-insulating layer 47 and the insulating cover layer 45 and thus form an annular gap. A pipeline 51 is arranged within the heat-insulating layer 47. The pipeline is formed rotationally symmetrically about a symmetry axis 53 and is basically completely surrounded by the heat-insulating layer 47.

As can be seen in FIG. 5, a plurality of openings 55 are provided in the insulating cover layer 45. The openings 55 can be formed at regular or irregular interspacings in the insulating cover layer 45 and in normal operation serve as means for ventilating the interior of the heat-insulating layer 47 and annular gap. The openings 55 also serve for the discharge of condensation water that is formed in the interior of the heat-insulating layer, and in particular in the vicinity of the pipeline 51. According to the invention the openings 55 can of course also be used for the insertion of the pointed section 3 and penetrating body 5 (see FIG. 7).

The spatial arrangement of a heat-insulated pipeline 43 is illustrated in FIG. 6. The structural elements correspond in large part to those known from FIGS. 4 and 5, and accordingly reference is made to the description relating thereto. It can additionally be seen in FIG. 6 however that the spacer layer 49 with the contoured elements 61 is fixed around the heat-insulating layer by means of a clamping ring 57. Depending on the strength of the clamping force of the clamping ring 57, this can also compress the material of the heat-insulating layer 47. The insulating cover layer 45 is closed by means of two bolts 59.

FIG. 7 shows schematically a pipeline system comprising a pipeline 51 that is surrounded by a heat-insulating layer 47. The heat-insulating layer 47 is for its part surrounded by a spacer layer 49, which comprises contoured elements 61 that form an annular gap between the heat-insulating layer 47 and an insulating cover layer 45. An opening 55 is formed in the cross-sectional plane in the insulating cover layer, through which is introduced a hand-device 1 according to the invention together with a penetrating body 6 (with a penetrating end 5 on a pointed section 3). The hand-device 1 in FIG. 7 is arranged in a position in which it penetrates the spacer layer 49 as well as the heat-insulating layer 47, and the holding section 29 abuts against the insulating cover layer 45. The embodiment illustrated in FIG. 7 has an interspacing between the penetrating end 5 of the pointed section 3 and the holding section 29, which allows the penetrating end 5 and the detecting device 63 arranged in the pointed section to approach the immediate vicinity of the pipeline 51. The penetration illustrated in FIG. 7 of the heat-insulating layers 47 takes place substantially in a radial direction. It is however clear that with another insertion direction of the hand-device 1 into the opening 55 different penetration paths within the heat-insulating layer 47 can also be selected.

### 2. EMBODIMENT FOR THE COMBINED DETECTION OF CORROSION AND MOISTURE

The hand-device according to FIG. 1 comprises a penetrating body 6 formed as a lance tube. The penetrating body 6 consists of a cylindrically shaped tube of corrosion-resistant material, for example stainless steel or a titanium alloy.

The hand-device 1 is introduced with the penetrating body 6 through an opening 55, which can be a ventilation bore in the outer insulating cover layer 45 or a bore provided specifically for this purpose, or without the use of an existing bore, into the material of the heat-insulating layer 47. Detection means, for example indicators 9, by means of which corrosion products or corrosion-relevant conditions such as for example moisture can be detected are disposed on the pointed section 3 of the penetrating body 6. For this purpose electrical conductors 28 and optical conductors 13, 19 are additionally incorporated in the hand-device 1 as detection means, in order to pass signals to the detecting device and transmit a necessary carrier signal or excitation signal to the surroundings.

Moisture is detected by an arrangement in which two electrodes 21, 23 insulated from one another (interspacing less than 1-2 mm) are arranged on the pointed section 3 of the penetrating body 6. In this connection one electrode 21 is the penetrating body 6 itself formed as a lance tube, while the other electrode 23 can be integrated in the surface. With this embodiment it has been found that moisture can be detected unambiguously in the heat-insulating layer 47 by measuring the electrical resistance. Very high resistance values (>1 MOhnm) indicate that the heat-insulating layer is dry (not wet). Resistance values below 1 kOhm indicate that the heat-insulating layer is wet.

The detection of corrosion products of the material of the pipeline 51, in particular rust or Fe ions, is performed colorimetrically by means of the light guides 13, 19 or alternatively spectroscopically via a chemical indicator 9. For this, light is transmitted up to the penetrating end 5 of the lance tube by means of the light guide 13 disposed in the penetrating body 6 formed as a lance tube. In the colorimetric analysis the reflected light is passed by means of another light guide 19 in the lance tube formed as the penetrating body 6, to a VIS spectrometer. Depending on the composition of the colour of the back-scattered and immitted light, it can be determined whether rust is present in the surroundings of the penetrating end 5, proximal to which is arranged the detecting device. Since also the material of the heat-insulating layer 47 has an intrinsic colour, for the purposes of this detection it is necessary to calibrate the light composition as regards the colour spectrum for the rust detection. For this purpose these measurement values are compared with values of a standard colour chart, in order to determine thereby the optical range for the rust detection.

Apart from the colour detection method, a preferred detection of rust or Fe ions within the heat-insulating layer 47 is achieved by applying a transparent carrier material (gel, non-woven material, etc.), which contains a chemical indicator for detecting Fe ions, to the penetrating end 5 of the penetrating body 6 formed as a lance tube, preferably a plate 7. This indicator exhibits a colour specifically on contact with Fe ions. This coloration can then be detected by means of the VIS spectrometer. The carrier material must be made so that it does not abrade or is mechanically protected when the penetrating body 6 is inserted into the heat-insulating layer 47. It must be sufficiently fluid to be able to absorb Fe ions. For the detection of dry rust the pH in the carrier material can be lowered so as to dissolve rust quickly and detect the released Fe ions. In order to avoid an attack or a solubilisation for example of a steel substrate itself, an inhibitor, for example urotropine, is additionally added to the carrier material.

The chemical detection can be based on conventional Fe indicators, for example hexacyanoferrate complex, which turns blue in the presence of Fe (“Berlin Blue”), or potassium thyocyanate (KSCN), which turns red in the presence of Fe ions.

Since the coloration of the indicator is irreversible, the pointed section 3 is preferably replaceable, so as to be able to apply further carrier material with indicator.

1. Hand-device for penetrating a heat-insulating layer of a corrodible metal object, and for examining the metallic object for corrosion, preferably for penetrating a heat-insulating layer of a corrodible metal pipeline, with
a penetrating body, which comprises a pointed section for displacing the insulating layer and a holding section for receiving a driving force, and
a detecting device for generating a signal in response to a stimulus caused by corrosion,
wherein the detecting device is arranged proximally to the pointed section of the penetrating body.

2. Hand-device according to claim 1, characterised in that the pointed section is reversibly detachably arranged on a base element of the penetrating body.

3. Hand-device according to claim 1, characterised in that the penetrating body and/or the pointed section has/have a circular, elliptical or polygonal cross-section.

4. Hand-device according to claim 1, characterised in that the penetrating body and/or the pointed section is/are formed straight, curved or spirally shaped.

5. Hand-device according to claim 1, characterised in that the penetrating body and/or the pointed section has/have a cross-sectional diameter in the range from 4 to 20 mm.

6. Hand-device according to claim 1, characterised in that the distance between the penetrating end of the pointed section of the penetrating body and the holding section is in the range from 150 to 1000 mm.

7. Hand-device according to claim 1, characterised in that the holding section has a length in the range from 110 to 220 mm.

8. Hand-device according to claim 1, characterised in that the pointed section is formed at its penetrating end as a unilaterally tapered or multilaterally tapered wedge, or as a wedge-shaped or projectile-shaped tip, or as a wedge-shaped, spherical or projectile stump.

9. Hand-device according to claim 1, characterised in that the detecting device is formed as a replaceable part.

10. Hand-device according to claim 9, characterised in that the detecting device is replaceably arranged in a recess, wherein the recess is formed in the penetrating body, preferably in the pointed section.

11. Hand-device according to claim 1, characterised in that the detecting device comprises detection means, wherein the detection means are intended for the detection of a stimulus produced by corrosion and preferably for the detection of water, and comprise a plurality of electrodes, and/or one or more light guides, and/or an indicator responding to the stimulus to be identified.

12. Hand-device according to claim 1, characterised in that the penetrating body is formed as a hollow body, wherein in the interior of the hollow body are arranged
signal lines for transmitting the signals representative of the stimulus to be identified, and/or
power supply means, and/or
means for the transporting and/or disposal or one or more of the detection means.

13. Hand-device according to claim 1, characterised in that the holding section comprises
power supply means and/or
means for transmitting signals from the detecting device to a device for processing the signals.

14. Hand-device according to claim 1, characterised in that the hand-device comprises a device for processing the signals and optionally a device for displaying results of the signal processing, wherein the device for processing the signals and optionally the device for displaying results of the signal processing is preferably arranged within the holding section and/or within the penetrating body.

15. Hand-device according claim 1, furthermore containing a guide device for the guided penetration of the insulating layer, with a recess through which the pointed section and the penetrating body extend, preferably free of play, wherein the guide device preferably comprises a handle.

16. Hand-device according to claim 1, characterised in that the holding section is ergonomically contoured for gripping with one or both hands, and/or an extension element is arranged on the holding section.

17. Method for examining a corrodible metal object provided with a heat-insulating layer for corrosion, preferably a pipeline surrounded by a heat-insulating layer, comprising the following steps:
penetrating the heat-insulating layer by means of a hand-device according to claim 1, so that the pointed section abuts against the object, or is spaced from the object by a distance of less than 50 mm, and
examining the object for corrosion by means of the detecting device.

18. Method according to claim 17 for examining a pipeline surrounded by a heat-insulating layer, comprising one or more of the following steps:
forming an opening in the insulating cover layer of a heat-insulated pipeline,
penetrating a spacer layer that surrounds the heat-insulating layer,
reading the detected measurement values.

19. Method for examining a pipeline surrounded by a heat-insulating layer for corrosion and preferably for detecting moisture by penetrating the heat-insulating layer with the hand-device of claim 1.

20. Pipeline system with a device for detecting corrosion products, comprising a pipeline, a heat-insulating layer surrounding the pipeline, and a hand-device according to claim 1 for penetrating the material of the heat-insulating layer.

21. Pipeline system according to claim 20, characterised by a spacer layer of a contoured material, which is arranged between the heat-insulating layer and an insulating cover layer, wherein the hand-device penetrates the spacer layer.

22. Hand-device according to claim 2, characterised in that:
the penetrating body and/or the pointed section has/have a circular, elliptical or polygonal cross-section;
the penetrating body and/or the pointed section is/are formed straight, curved or spirally shaped;
the penetrating body and/or the pointed section has/have a cross-sectional diameter in the range from 4 to 20 mm;
the distance between the penetrating end of the pointed section of the penetrating body and the holding section is in the range from 150 to 1000 mm;
the holding section has a length in the range from 110 to 220 mm;
the pointed section is formed at its penetrating end as a unilaterally tapered or multilaterally tapered wedge, or as a wedge-shaped or projectile-shaped tip, or as a wedge-shaped, spherical or projectile stump;
the detecting device is formed as a replaceable part;
the detecting device is replaceably arranged in a recess, wherein the recess is formed in the penetrating body, preferably in the pointed section;
the detecting device comprises detection means, wherein the detection means are intended for the detection of a stimulus produced by corrosion and preferably for the detection of water, and comprise a plurality of electrodes, and/or one or more light guides, and/or an indicator responding to the stimulus to be identified;
the penetrating body is formed as a hollow body, wherein in the interior of the hollow body are arranged
signal lines for transmitting the signals representative of the stimulus to be identified, and/or
power supply means, and/or
means for the transporting and/or disposal or one or more of the detection means;
the holding section comprises
power supply means and/or
means for transmitting signals from the detecting device to a device for processing the signals;
the hand-device comprises a device for processing the signals and optionally a device for displaying results of the signal processing, wherein the device for processing the signals and optionally the device for displaying results of the signal processing is preferably arranged within the holding section and/or within the penetrating body;
the hand-device further contains a guide device for the guided penetration of the insulating layer, with a recess through which the pointed section and the penetrating body extend, preferably free of play, wherein the guide device preferably comprises a handle; and
the holding section is ergonomically contoured for gripping with one or both hands, and/or an extension element is arranged on the holding section.

23. Method for examining a corrodible metal object provided with a heat-insulating layer for corrosion, preferably a pipeline surrounded by a heat-insulating layer, comprising the following steps:
penetrating the heat-insulating layer by means of a hand-device according to claim 22, so that the pointed section abuts against the object, or is spaced from the object by a distance of less than 50 mm, and
examining the object for corrosion by means of the detecting device.

24. Method according to claim 23 for examining a pipeline surrounded by a heat-insulating layer, comprising one or more of the following steps:
forming an opening in the insulating cover layer of a heat-insulated pipeline,
penetrating a spacer layer that surrounds the heat-insulating layer,
reading the detected measurement values.

25. Method for examining a pipeline surrounded by a heat-insulating layer for corrosion and preferably for detecting moisture by penetrating the heat-insulating layer with the hand-device of claim 22.

26. Pipeline system with a device for detecting corrosion products, comprising a pipeline, a heat-insulating layer surrounding the pipeline, and a hand-device according to claim 22 for penetrating the material of the heat-insulating layer.

27. Pipeline system according to claim 26, characterised by a spacer layer of a contoured material, which is arranged between the heat-insulating layer and an insulating cover layer, wherein the hand-device penetrates the spacer layer.
